(19) United States
(12) Patent Application Publication
(10) Pub. No.: US 2025/0069263 A1
(43) Pub. Date: Feb. 27, 2025

(54) OBJECT DETECTION SYSTEM, OBJECT DETECTION APPARATUS, OBJECT DETECTION METHOD, AND NON-TRANSITORY COMPUTER-READABLE MEDIUM

(71) Applicant: NEC Corporation, Tokyo (JP)

(72) Inventors: Tatsuya FUJIMOTO, Tokyo (JP); Junichi ABE, Tokyo (JP); Hidemi NOGUCHI, Tokyo (JP)

(73) Assignee: NEC Corporation, Tokyo (JP)

(21) Appl. No.: 18/796,607

(22) Filed: Aug. 7, 2024

(30) Foreign Application Priority Data
Aug. 22, 2023 (JP) 2023-134512

(51) Int. Cl. G06T 7/73; G06V 10/46

(52) U.S. Cl. CPC G06T 7/75; G06V 10/46; G06T 2207/10028

(57) ABSTRACT

An object detection system includes: a point cloud missing region extraction means for extracting a point cloud missing region being a region where a point cloud is missing in a three-dimensional point cloud; and an object estimation means for estimating presence of an object, based on the point cloud missing region.

### INCORPORATION BY REFERENCE

This application is based upon and claims the benefit of priority from Japanese patent application No. 2023-134512, filed on Aug. 22, 2023, the disclosure of which is incorporated herein in its entirety by reference.

### TECHNICAL FIELD

The present disclosure relates to an object detection system, an object detection apparatus, an object detection method, and a program.

### BACKGROUND ART

Japanese Unexamined Patent Application Publication No. 2019-3527 discloses a technique for detecting a utility pole, a traffic light, and a guardrail, based on a three-dimensional point cloud.

### SUMMARY

A light detection and ranging (LiDAR) apparatus is known as a means for generating a three-dimensional point cloud. The LiDAR apparatus generates, by using laser light, a three-dimensional point cloud being a ranging target. Herein, the LiDAR apparatus is a ranging apparatus on an assumption that the laser light emitted toward the ranging target is reflected by a surface of the ranging target and is input to the LiDAR apparatus again.

Accordingly, when a metal object that specularly reflects the laser light emitted from the LiDAR apparatus is included in the ranging target, a three-dimensional point cloud associated with the metal object is not generated, and therefore, the metal object cannot be detected based on the three-dimensional point cloud. The same applies to a black body, such as charcoal, that is less likely to reflect the laser light emitted from the LiDAR apparatus.

An example object of the present disclosure is to provide a technique for, at a time of object detection based on a three-dimensional point cloud, detecting the object even when a three-dimensional point cloud associated with the object cannot be acquired.

In a first example aspect according to the present disclosure, an object detection system includes: a point cloud missing region extraction unit configured to extract a point cloud missing region being a region where a point cloud is missing in a three-dimensional point cloud; and an object estimation unit configured to estimate presence of an object, based on the point cloud missing region.

In a second example aspect, an object detection apparatus includes:
a point cloud missing region extraction unit configured to extract a point cloud missing region being a region where a point cloud is missing in a three-dimensional point cloud; and
an object estimation unit configured to estimate presence of an object, based on the point cloud missing region.

In a third example aspect, an object detection method includes:
extracting a point cloud missing region being a region where a point cloud is missing in a three-dimensional point cloud; and
estimating presence of an object, based on the point cloud missing region.

In a fourth example aspect, a program causes a computer to function as:
a point cloud missing region extraction unit configured to extract a point cloud missing region being a region where a point cloud is missing in a three-dimensional point cloud; and
an object estimation unit configured to estimate presence of an object, based on the point cloud missing region.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram of an object detection system;

FIG. 2 is a block diagram of an object detection apparatus;

FIG. 3 is a control flow of the object detection apparatus;

FIG. 4 is an extraction flow for a point cloud missing region;

FIG. 5 is a distribution diagram of point density index values;

FIG. 6 is an object estimation flow;

FIG. 7 is an object estimation flow;

FIG. 8 is an extraction flow for a point cloud missing region;

FIG. 9 is an extraction flow for the point cloud missing region;

FIG. 10 is a distribution diagram of the point density index values;

FIG. 11 is a specific example of an appearance mode of the point cloud missing region;

FIG. 12 is a specific example of an appearance mode of the point cloud missing region;

FIG. 13 is an extraction flow for the point cloud missing region and an object estimation flow;

FIG. 14 is a diagram illustrating two point cloud missing regions partially overlapped with each other;

FIG. 15 is a block diagram of a train equipped with an object detection apparatus;

FIG. 16 is a diagram illustrating a case where a processing circuit included in the object detection apparatus is constituted of a processor and a memory; and

FIG. 17 is a diagram illustrating a case where a processing circuit included in the object detection apparatus is constituted of dedicated hardware.

### EXAMPLE EMBODIMENT

### Outline of Present Disclosure

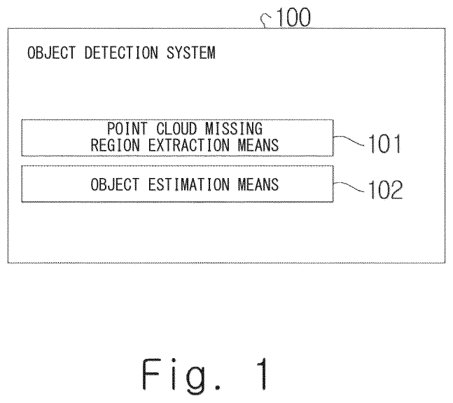

First, an outline of the present disclosure is described. FIG. 1 illustrates a block diagram of an object detection system.

As illustrated in FIG. 1, an object detection system 100 includes a point cloud missing region extraction means 101 and an object estimation means 102.

The point cloud missing region extraction means 101 extracts a point cloud missing region being a region where a point cloud is missing in the three-dimensional point cloud.

The object estimation means 102 estimates the presence of an object, based on the point cloud missing region.

According to the above-described configuration, at the time of object detection based on a three-dimensional point cloud, an object can be detected even when a three-dimensional point cloud associated with the object cannot be acquired.

### First Example Embodiment

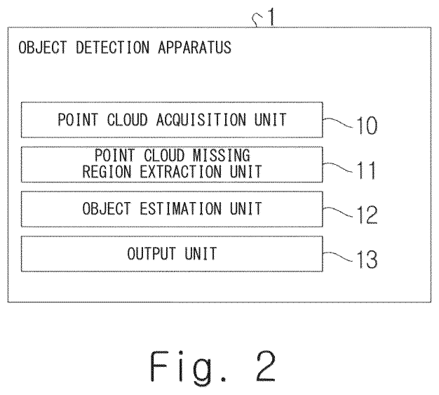

Next, a first example embodiment of the present disclosure is described. FIG. 2 is a block diagram of an object detection apparatus 1. The object detection apparatus 1 illustrated in FIG. 2 is an apparatus that detects an object, based on a three-dimensional point cloud.

The object detection apparatus 1 includes a point cloud acquisition unit 10, a point cloud missing region extraction unit 11, an object estimation unit 12, and an output unit 13.

The point cloud acquisition unit 10 acquires a three-dimensional point cloud. A three-dimensional point cloud may typically be generated using a light detection and ranging (LiDAR) apparatus, a radio detection and ranging (RADAR) devoice, a stereo-camera, or a combination thereof. Alternatively, a three-dimensional point cloud may be generated from a plurality of two-dimensional images through a structure from motion (SfM).

The point cloud acquisition unit 10 may acquire a three-dimensional point cloud from a LiDAR apparatus (not illustrated) included in the object detection apparatus 1. The point cloud acquisition unit 10 may acquire a three-dimensional point cloud from a LiDAR apparatus provided outside the object detection apparatus 1. Further, the point cloud acquisition unit 10 may acquire a three-dimensional point cloud from an external apparatus via a communication network.

The three-dimensional point cloud acquired by the point cloud acquisition unit 10 includes, in addition to the three-dimensional coordinate value of each point, data such as a reflection luminance value of each point and a ranging position of the LiDAR apparatus at the time of ranging. The three-dimensional coordinate value of each point is represented by a coordinate system fixed to the LiDAR apparatus. The ranging position of the LiDAR apparatus is typically expressed in a world coordinate system.

The point cloud missing region extraction unit 11 is configured to extract a point cloud missing region being a region where a point cloud is locally missing in the three-dimensional point cloud.

The object estimation unit 12 is configured to estimate the presence of an object, based on the point cloud missing region extracted by the point cloud missing region extraction unit 11.

The output unit 13 outputs an estimation result acquired by the object estimation unit 12. The output unit 13 is, for example, a display or a speaker. When the object estimation unit 12 estimates that an object is present, the output unit 13 displays a warning screen on the display. Alternatively, when the object estimation unit 12 estimates that an object is present, the output unit 13 may output a warning sound from the speaker.

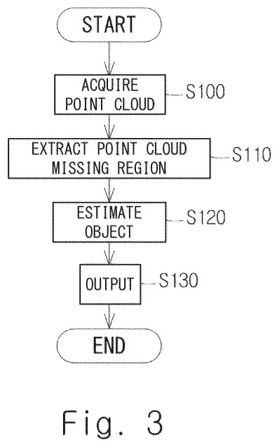

FIG. 3 illustrates an operation flow of the object detection apparatus 1. As illustrated in FIG. 3, first, the point cloud acquisition unit 10 acquires a three-dimensional point cloud (S100). Next, the point cloud missing region extraction unit 11 extracts a point cloud missing region being a region where a point cloud is locally missing in the three-dimensional point cloud (S110). Next, the object estimation unit 12 estimates the presence of the object, based on the point cloud missing region (S120). Then, the output unit 13 outputs an estimation result acquired by the object estimation unit 12 (S130).

Next, the point cloud missing region extraction unit 11 and the object estimation unit 12 is described in detail in order.

### (Point Cloud Missing Region Extraction Unit 11)

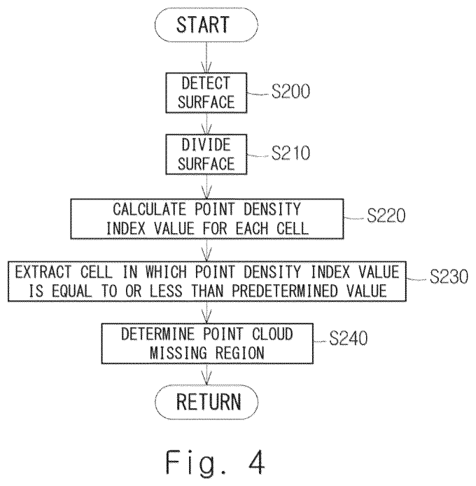

As described above, the point cloud missing region extraction unit 11 extracts a point cloud missing region being a region where a point cloud is locally missing in the three-dimensional point cloud. FIG. 4 illustrates an operation flow of the point cloud missing region extraction unit 11.

### S200:

First, the point cloud missing region extraction unit 11 detects a surface, based on the three-dimensional point cloud. The surface is typically a ground surface composed of a flat or curved surface. The point cloud missing region extraction unit 11 detects a surface by, for example, performing clustering processing on the three-dimensional point cloud. In such a case, when a plurality of point clouds belonging to one cluster have substantially the same vertical coordinates, the point cloud missing region extraction unit 11 can detect one surface, based on the plurality of point clouds.

### S210:

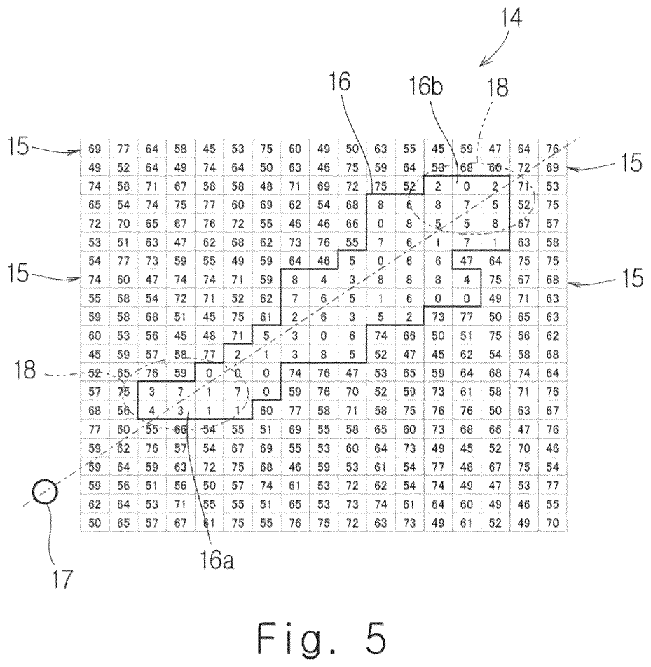

Next, the point cloud missing region extraction unit 11 divides, in a grid shape, the surface detected in step S200 into a plurality of cells. FIG. 5 illustrates a surface 14 detected in step S200. In addition, FIG. 5 illustrates a plurality of cells 15 arranged in a grid. In the present example embodiment, the plurality of cells 15 have the same area. Alternatively, however, the plurality of cells 15 may have different areas.

### S220:

Next, the point cloud missing region extraction unit 11 calculates a point density index value of each cell 15. The point density index value is an index value that directly or indirectly indicates the density of the point cloud in each cell 15. In the present example embodiment, the point density index value indirectly indicates the density of the point cloud in each cell 15. That is, in the present example embodiment, since the areas of the plurality of cells 15 have the same area, the point density index value can be defined as the number of point clouds belonging to a relevant cell 15. For example, when the point density index value is 65, it means that there are 65 points in the relevant cell 15. In FIG. 5, the point density index value is directly described in each cell 15. The point density index value may be defined as a value acquired by dividing the number of point clouds belonging to the relevant cell 15 by the area of the cell 15. In such a case, the point density index value directly indicates the density of the point cloud in each cell 15.

### S230:

Next, the point cloud missing region extraction unit 11 extracts a cell in which the point density index value satisfies a predetermined condition. In the present example embodiment, when the point density index value is equal to or less than the predetermined value, it is assumed that the point density index value satisfies the predetermined condition. In the present example embodiment, as illustrated in FIG. 5, the point density index values of the plurality of cells 15 are widely distributed around 5 and around 60. Therefore, in the present example embodiment, the point cloud missing region extraction unit 11 extracts a cell having a point density index value of 30 or less.

### S240:

Next, the point cloud missing region extraction unit 11 determines a set of cells 15 extracted in step S230 as the point cloud missing region 16. In FIG. 5, a point cloud missing region 16 is surrounded by a thick solid line.

### (Object Estimation Unit 12)

As described above, the object estimation unit 12 estimates the presence of the object, based on the point cloud missing region 16. Examples of the estimation performed by the object estimation unit 12 include, but are not limited to, the following first estimation method, second estimation method, and third estimation method.

### <First Estimation Method>

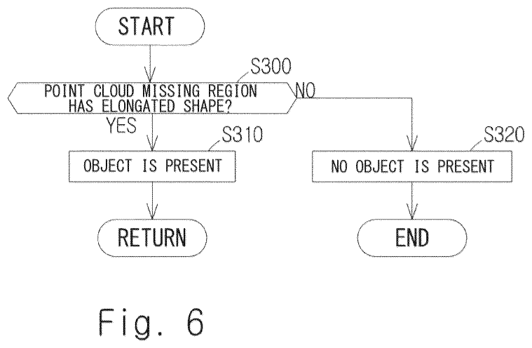

FIG. 6 illustrates a specific example of an estimation flow of the object estimation unit 12.

As illustrated in FIG. 6, the object estimation unit 12 determines whether the point cloud missing region 16 has an elongated shape (S300). Specifically, the object estimation unit 12 can calculate a quadrangle circumscribing the point cloud missing region 16 and determine whether the point cloud missing region 16 has an elongated shape, based on the aspect ratio of the quadrangle. When it is determined that the point cloud missing region 16 has an elongated shape (S300: YES), the object estimation unit 12 estimates that an object 18 is present in the point cloud missing region 16 (S310). Specifically, the object estimation unit 12 may estimate that the object 18 is present at either one of the end portions 16a and 16b in the longitudinal direction of the point cloud missing region 16. Further, the object estimation unit 12 may estimate that the object 18 is present at the end portion 16a close to the LiDAR apparatus 17 among the end portions 16a and 16b in the longitudinal direction of the point cloud missing region 16.

Meanwhile, when it is determined that the point cloud missing region 16 does not have an elongated shape (S300: NO), the object estimation unit 12 estimates that no object is present in the point cloud missing region 16 (S320), and ends the process. This is because, for example, when the ranging target is 600 meters away from the LiDAR apparatus in a horizontal distance, the point cloud missing region 16 is supposed to extend in an elongated shape if the point cloud missing region 16 is caused by an object 18 placed on the ground.

### <Second Estimation Method>

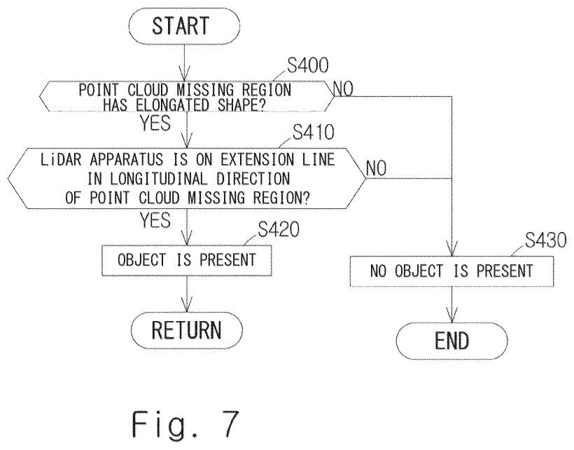

FIG. 7 illustrates another specific example of the estimation flow of the object estimation unit 12.

As illustrated in FIG. 7, the object estimation unit 12 determines whether the point cloud missing region 16 has an elongated shape (S400). When it is determined that the point cloud missing region 16 has an elongated shape (S400: YES), the object estimation unit 12 determines whether the LiDAR apparatus 17 is present on the extension line in the longitudinal direction of the point cloud missing region 16 (S410). When it is determined that the LiDAR apparatus 17 is present on the extension line in the longitudinal direction of the point cloud missing region 16 (S410: YES), the object estimation unit 12 estimates that the object 18 is present in the point cloud missing region 16 (S420). Specifically, the object estimation unit 12 may estimate that an object is present at either of the end portions 16a and 16b in the longitudinal direction of the point cloud missing region 16. Further, the object estimation unit 12 may estimate that an object is present at the end portion 16a close to the LiDAR apparatus 17 among the end portions 16a and 16b in the longitudinal direction of the point cloud missing region 16.

Meanwhile, when it is determined that the point cloud missing region 16 does not have an elongated shape (S400: NO), the object estimation unit 12 estimates that there is no object in the point cloud missing region 16 (S430), and ends the process. This is because, for example, when the ranging target is 600 meters away from the LiDAR apparatus in the horizontal distance, the point cloud missing region 16 is supposed to extend in an elongated shape if the point cloud missing region 16 is caused by an object 18 placed on the ground.

Further, when it is determined that the LiDAR apparatus 17 is not present on the extension line in the longitudinal direction of the point cloud missing region 16 (S410: NO), the object estimation unit 12 estimates that there is no object in the point cloud missing region 16 (S430), and ends the process. This is because, for example, when the ranging target is 600 meters away from the LiDAR apparatus in the horizontal distance, the point cloud missing region 16 is supposed to be extended in a direction away from the LiDAR apparatus 17 if the point cloud missing region 16 is caused by the object 18 placed on the ground.

### <Third Estimation Method>

When the point cloud missing region extraction unit 11 extracts the point cloud missing region 16, the object estimation unit 12 may estimate that the object 18 is present in the point cloud missing region 16 regardless of the shape or the extending direction of the point cloud missing region 16. This is because, for example, when the LiDAR apparatus 17 is disposed at a position higher in the vertical direction than the object 18, the point cloud missing region 16 generated due to the object 18 placed on the ground is not necessarily extend in an elongated shape.

The first example embodiment of the present disclosure has been described above, and the above-described example embodiment has the following features.

The object detection apparatus 1 includes a point cloud missing region extraction unit 11 configured to extract a point cloud missing region 16 being a region where a point cloud is missing in a three-dimensional point cloud, and an object estimation unit 12 configured to estimate the presence of the object 18, based on the point cloud missing region 16. According to the above-described configuration, at the time of object detection based on the three-dimensional point cloud, the object can be detected even when the three-dimensional point cloud associated with the object cannot be acquired.

As illustrated in FIG. 5, the point cloud missing region 16 is a region within the surface 14 detected based on the three-dimensional point cloud.

As illustrated in FIG. 5, the point cloud missing region extraction unit 11 divides, in a grid shape, the surface 14 into a plurality of cells 15. The point cloud missing region extraction unit 11 calculates a point density index value of each cell 15. The point cloud missing region extraction unit 11 extracts, as the point cloud missing region 16, a set of cells 15 having a point density index value that satisfies a predetermined condition. According to the above-described configuration, it is possible to suppress the calculation cost for extracting the point cloud missing region.

As illustrated in FIG. 5, the object estimation unit 12 estimates that the object 18 is present at the end portion 16a or 16b in the longitudinal direction of the point cloud missing region 16. According to the above-described configuration, the position of the object 18 can be estimated with high accuracy.

### Second Example Embodiment

Next, a second example embodiment of the present disclosure is described. Hereinafter, the present example embodiment is mainly described in terms of differences from the above-described first example embodiment, and redundant description is omitted. The present example embodiment is different from the first example embodiment in an operation of a point cloud missing region extraction unit 11.

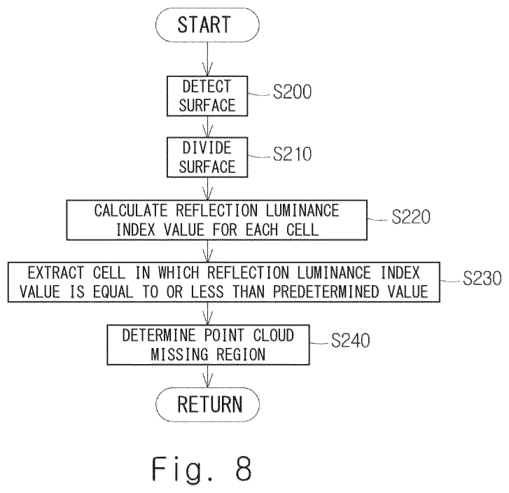

FIG. 8 illustrates an operation flow of a point cloud missing region extraction unit 11. Steps S200, S210, and S240 in the operation flow illustrated in FIG. 8 are the same as those in the first example embodiment.

### S220:

The point cloud missing region extraction unit 11 calculates a reflection luminance index value of each cell 15. The reflection luminance index value is an index value that directly or indirectly indicates the reflection luminance of the point cloud in each cell 15. In the present example embodiment, the reflection luminance index value is a representative value of the reflection luminance of the point cloud in each cell 15. The representative value of the reflection luminance of the point cloud is, for example, any one of a mean value of the reflection luminance of the point cloud, a median value of the reflection luminance of the point cloud, and a mode of the reflection luminance of the point cloud, but are not limited thereto.

### S230:

Next, the point cloud missing region extraction unit 11 extracts, for each cell 15, a cell having a reflected luminance index value that satisfies a predetermined condition. In the present example embodiment, when the reflected luminance index value is equal to or less than the predetermined value, it is assumed that the reflected luminance index value satisfies the predetermined condition.

As described above, in the present example embodiment, the point cloud missing region extraction unit 11 extracts the point cloud missing region 16, based on the reflection luminance of the point cloud. For example, when an object 18 detected by an object detection apparatus 1 is a light transmissive material having both reflection and transmission characteristics, such as glass, the reflection luminance of the point cloud in the point cloud missing region 16 associated with the object 18 is distributed around 30 as an example. Therefore, by setting the predetermined value to 10 in step S230, the object 18 can be detected without any problem even when the object 18 is a light transmissive material.

### Third Example Embodiment

Next, a third example embodiment of the present disclosure is described. Hereinafter, the present example embodiment is mainly described in terms of differences from the above-described first example embodiment, and redundant description is omitted. The present example embodiment is different from the first example embodiment in an operation of a point cloud missing region extraction unit 11.

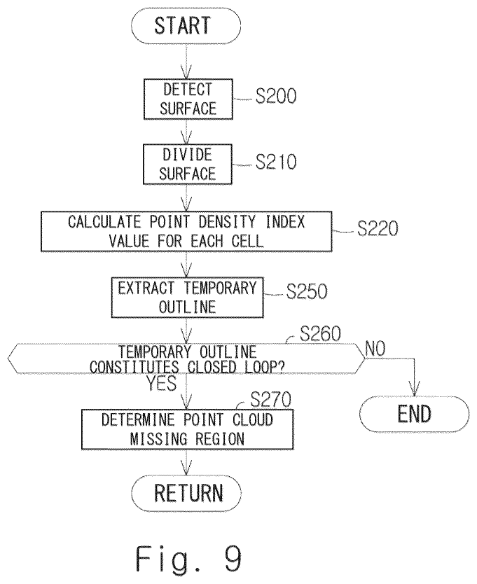

FIG. 9 illustrates an operation flow of the point cloud missing region extraction unit 11. Steps S200 to S220 in the operation flow illustrated in FIG. 8 are the same as those in the first example embodiment. In the present example embodiment, the point cloud missing region extraction unit 11 detects the outline of the point cloud missing region 16, based on a difference between the point density index values between two adjacent cells 15, and extracts the point cloud missing region 16, based on the detection result. Specifically, the operation is as follows.

### S250:

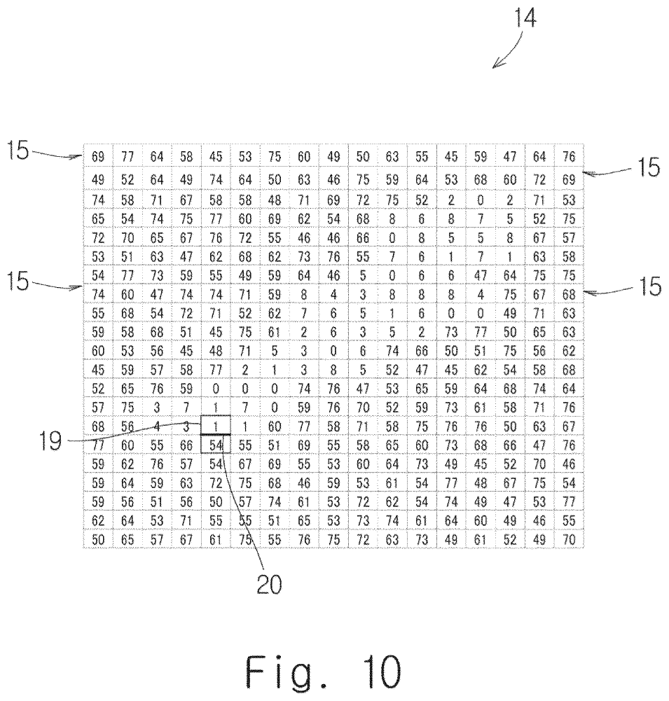

First, the point cloud missing region extraction unit 11 calculates a difference between the point density index values between two adjacent cells 15. In FIG. 10, two adjacent cells 15 are surrounded by a solid line 19. The difference between the point density index values among the two cells 15 surrounded by the solid line 19 is 53. When the difference exceeds a predetermined value, the point cloud missing region extraction unit 11 sets a temporary outline 20 between the two cells 15. Similarly, the point cloud missing region extraction unit 11 performs the above-described difference calculation on all the cells 15, and sets a plurality of temporary outlines 20.

### S260:

Next, the point cloud missing region extraction unit 11 determines whether the plurality of temporary outlines 20 set in step S250 constitute a closed loop. When it is determined that the plurality of temporary outlines 20 constitute a closed loop (S260: YES), the point cloud missing region extraction unit 11 extracts the plurality of cells 15 surrounded by the plurality of temporary outlines 20. Meanwhile, when it is determined that the plurality of temporary outlines 20 do not constitute a closed loop (S260: NO), the point cloud missing region extraction unit 11 determines that there is no point cloud missing region, and ends the process.

### S270:

Next, the point cloud missing region extraction unit 11 determines the set of cells 15 extracted in step S260 as the point cloud missing region 16.

As described above, in the present example embodiment, the point cloud missing region extraction unit 11 extracts the point cloud missing region 16 by detecting the outline of the point cloud missing region 16. As is well known, the point density of the three-dimensional point cloud increases or decreases according to the distance from the LiDAR apparatus. For example, in a region relatively far from the LiDAR apparatus, the point density is relatively low, and in a region relatively close to the LiDAR apparatus, the point density is relatively high. Therefore, similarly, in the point cloud missing region 16, the point density is relatively low in a region relatively far from the LiDAR apparatus, and the point density is relatively high in a region relatively close to the LiDAR apparatus. Even when there is a gradient in the point density according to the distance from the LiDAR apparatus as described above, the extraction method according to the present example embodiment makes it possible to reliably extract the point cloud missing region 16.

Note that the point cloud missing region extraction unit 11 may calculate the reflected luminance index value of each cell 15 instead of calculating the point density index value of each cell 15.

In addition, instead of calculating the point density index value or the reflected luminance index value of each cell 15, the point cloud missing region extraction unit 11 may: first, divide a space into voxel grids, calculate a difference between the point densities of adjacent voxel grids, and extract the point cloud missing region 16 based on the difference; and second, calculate a point density index value or a reflected luminance index value for each point constituting the three-dimensional point cloud. For example, the number of point clouds in a virtual sphere having a predetermined radius and centered on a certain point constituting the three-dimensional point cloud may be used as the point density index value of the relevant point. In short, it is only necessary to calculate the distribution mode of the three-dimensional point cloud acquired by a point cloud acquisition unit 10 to the extent that the point cloud missing region 16 can be extracted. Therefore, instead of calculating the point density index value and the reflected luminance index value of each cell 15, the point cloud missing region extraction unit 11 may calculate a representative value of the polarization, phase, or frequency acquired from the characteristics of the light of a light receiving pulse associated with the point cloud of each cell 15.

### Fourth Example Embodiment

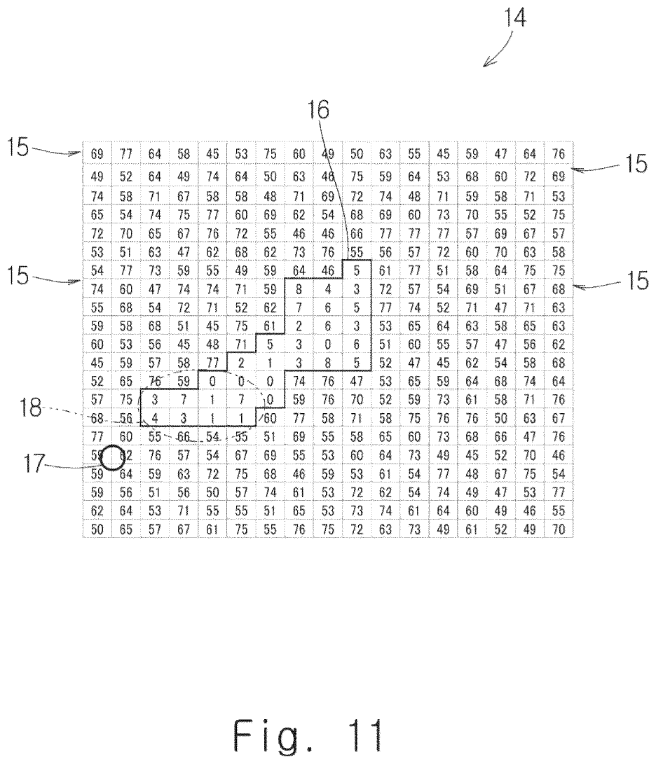

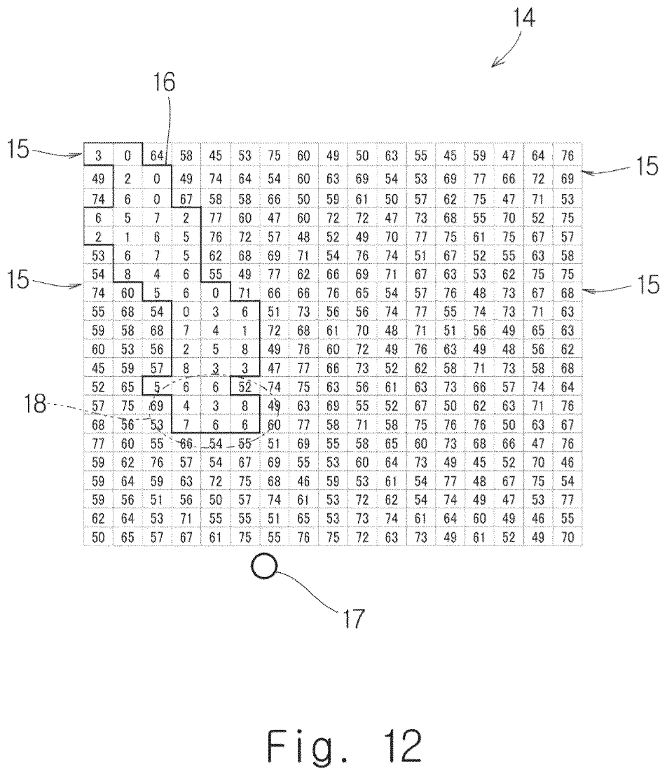

Next, a fourth example embodiment of the present disclosure is described. FIGS. 11 and 12 illustrate a specific example of an appearance mode of a point cloud missing region 16. As illustrated in FIGS. 11 and 12, the point cloud missing region 16 has a property of appearing in an elongated manner along a direction away from a LiDAR apparatus 17. That is, as illustrated in FIGS. 11 and 12, the point cloud missing region 16 appears in an elongated manner along an extension line of a line connecting the LiDAR apparatus 17 and an object 18.

If the point cloud missing region 16 in FIGS. 11 and 12 does not appear due to the object 18, but rather due to the characteristics of the ground, i.e., a mirror is placed on the ground or powder of coal is scattered on the ground, the point cloud missing region 16 extracted by a point cloud missing region extraction unit 11 may always have the same shape and extracted at the same position, regardless of the ranging position of the LiDAR apparatus 17. That is, the point cloud missing region 16 illustrated in FIG. 11 and the point cloud missing region 16 illustrated in FIG. 12 may completely overlap each other. In short, the point cloud missing region 16 illustrated in FIG. 11 and the point cloud missing region 16 illustrated in FIG. 12 may have the same outline.

Therefore, by comparing two point cloud missing regions 16 extracted from two three-dimensional point clouds generated before and after the ranging position of the LiDAR apparatus 17 shifts, the situation can be separated to whether the point cloud missing regions 16 are due to the object 18 placed on the ground, or due to the characteristics of the ground.

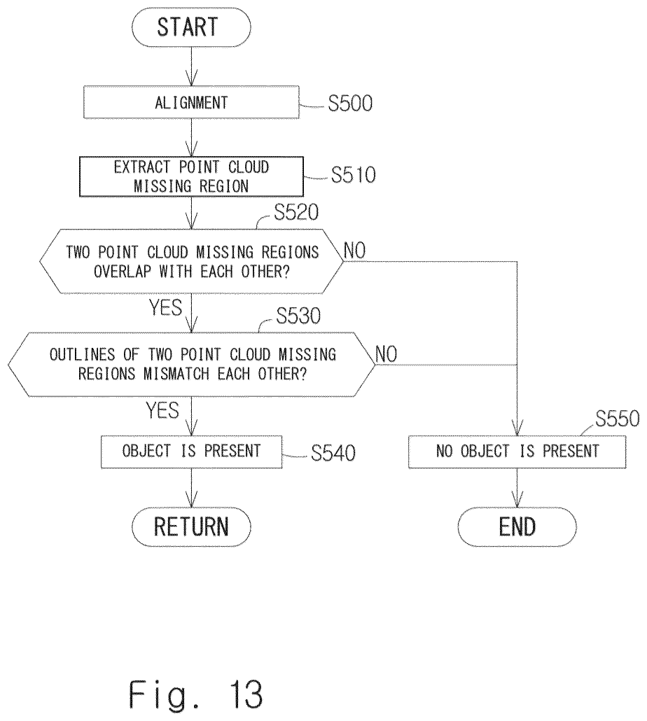

FIG. 13 illustrates a processing flow of the point cloud missing region extraction unit 11 and an object estimation unit 12.

### S500:

First, the point cloud missing region extraction unit 11 aligns a first three-dimensional point cloud and a second three-dimensional point cloud that differ from each other in the ranging position of the LiDAR apparatus 17 (that is, the position of the LiDAR apparatus 17 at the time of performing ranging) by using, for example, an iterative closest point (ICP). However, when the coordinate accuracies of the first three-dimensional point cloud and the second three-dimensional point cloud are both good, the alignment can be omitted.

### S510:

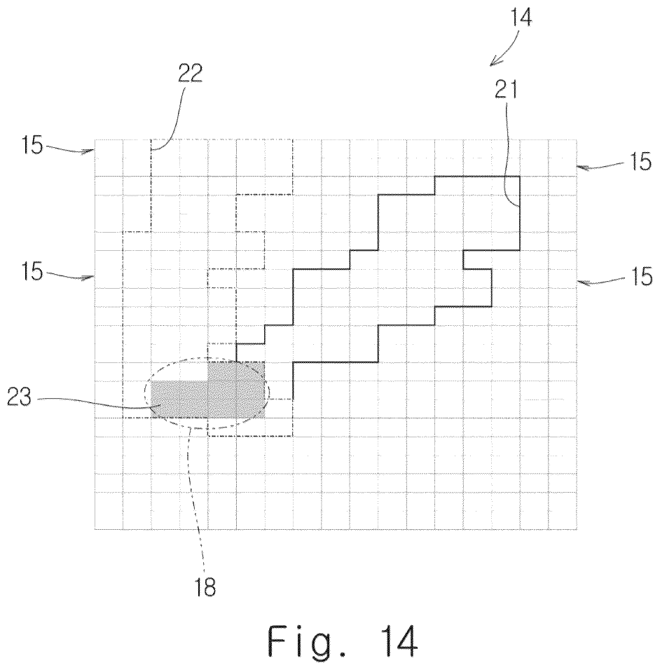

Next, the point cloud missing region extraction unit 11 extracts a first point cloud missing region and a second point cloud missing region in each of the first three-dimensional point cloud and the second three-dimensional point cloud. In FIG. 14, a first point cloud missing region 21 and a second point cloud missing region 22 are indicated by thick solid lines and dashed-dotted lines, respectively.

### S520:

Next, the object estimation unit 12 determines whether the first point cloud missing region 21 and the second point cloud missing region 22 overlap each other. When the first point cloud missing region 21 and the second point cloud missing region 22 are separated from each other without overlapping (S520: NO), the object estimation unit 12 estimates that there is no object (S550), and ends the process. Meanwhile, when the first point cloud missing region 21 and the second point cloud missing region 22 partially overlap each other (S520: YES), the object estimation unit 12 advances the process to step S530. Herein, [overlap each other] means [partially overlap each other] or [at least partially overlap each other].

### S530:

Next, the object estimation unit 12 determines whether the outlines of the first point cloud missing region 21 and the second point cloud missing region 22 mismatch each other. When the outlines of the first point cloud missing region 21 and the second point cloud missing region 22 mismatch each other (S530: YES), the object estimation unit 12 estimates that the object 18 is present in an overlapping region 23 of the first point cloud missing region 21 and the second point cloud missing region 22 (S540). Meanwhile, when the outlines of the first point cloud missing region 21 and the second point cloud missing region 22 match each other (S530: NO), the object estimation unit 12 estimates that there is no object in the overlap region 23 of the first point cloud missing region 21 and the second point cloud missing region 22 (S550), and ends the process.

By comparing the point cloud missing regions extracted from the two three-dimensional point clouds acquired at different ranging positions with each other as described above, erroneous detection of an object can be prevented.

The fourth example embodiment is as described above. The fourth example embodiment has the following features.

That is, the point cloud missing region extraction unit 11 extracts the first point cloud missing region 21 and the second point cloud missing region 22 in each of the first three-dimensional point cloud and the second three-dimensional point cloud in which the ranging positions of the LiDAR apparatus 17 (ranging apparatus) for generating the three-dimensional point cloud are different from each other. When the first point cloud missing region 21 and the second point cloud missing region 22 overlap and the outline of the first point cloud missing region 21 and the outline of the second point cloud missing region 22 do not match each other, the object estimation unit 12 estimates that the object 18 is present in the overlap region 23 of the first point cloud missing region 21 and the second point cloud missing region 22. According to the above-described configuration, it is possible to prevent erroneous detection of an object.

### Fifth Example Embodiment

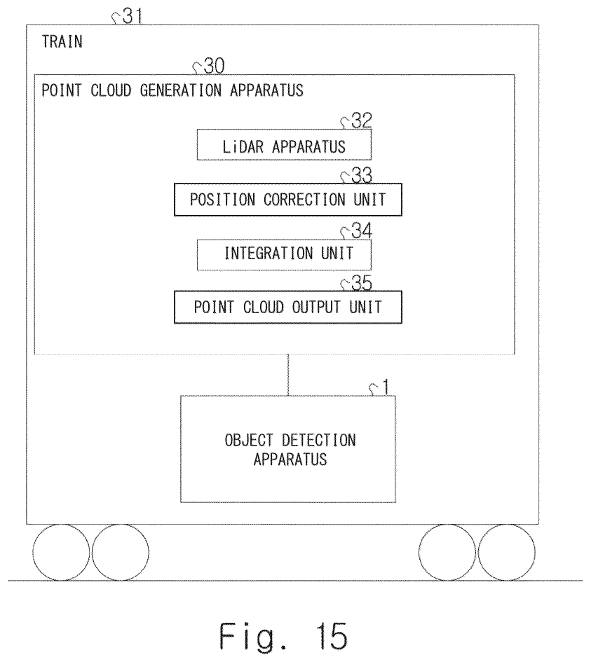

Next, a description is given of a case where a point cloud generation apparatus 30 configured to supply a three-dimensional point cloud to an object detection apparatus 1 is mounted on a train 31. The train 31 illustrated in FIG. 15 is a specific example of a moving body having the point cloud generation apparatus 30 mounted thereon. The moving body is not limited to the train 31, and may be an automobile, a moving robot, an aerial vehicle, or the like.

As illustrated in FIG. 15, the point cloud generation apparatus 30 includes a LiDAR apparatus 32, a position correction unit 33, an integration unit 34, and a point cloud output unit 35.

The LiDAR apparatus 32 performs ranging while the train 31 is moving. In a case where the LiDAR apparatus 32 is a so-called scanning LiDAR apparatus such as a raster scan type or a conical scan type, the ranging position and the ranging direction of the LiDAR apparatus 32 shift from time to time. Even in a so-called flash type LiDAR apparatus in which the LiDAR apparatus 32 collectively performs ranging at a certain time point, the ranging position and the ranging direction of the LiDAR apparatus 32 shift each time the ranging is performed.

The position correction unit 33 corrects the coordinates of each point of the three-dimensional point cloud generated by the LiDAR apparatus 32, based on the ranging position and the ranging direction of the LiDAR apparatus 32. For example, the ranging position of the LiDAR apparatus 32 indicates the acquisition location of the LiDAR apparatus 32 when the LiDAR apparatus 32 performs ranging. The ranging position of the LiDAR apparatus 32 can be acquired by various self-position estimation techniques. The self-position estimation techniques typically include a combination of a global navigation satellite system (GNSS) and an inertial measurement unit (IMU). Alternatively, simultaneous localization and mapping (SLAM) may be adopted as the self-position estimation technique. The ranging direction indicates the pose of the LiDAR apparatus 32 at the time of ranging. The ranging direction can be acquired based on an output value of an acceleration sensor or a geomagnetic sensor provided in the LiDAR apparatus 32.

The integration unit 34 integrates and holds a three-dimensional point cloud acquired in a first time period as a first three-dimensional point cloud. Further, the integration unit 34 integrates and holds a three-dimensional point cloud acquired in a second time period that is after the first time period. The lengths of the first time period and the second time period on the time axis may be adjusted as appropriate in such a way as to ensure the point density required to detect an detection object. The length of the first time period and the second time period on the time axis may be adjusted as appropriate according to the traveling speed of the train 31 and the size of the detection object.

The point cloud output unit 35 outputs the first three-dimensional point cloud and the second three-dimensional point cloud integrated by the integration unit 34 to the object detection apparatus 1.

The fifth example embodiment has the following features.

In a case where the LiDAR apparatus 32 is mounted on the train 31 and ranging by the LiDAR apparatus 32 is performed while the train 31 is moving, the first three-dimensional point cloud is a point cloud acquired by ranging in the first time period, and the second three-dimensional point cloud is a point cloud acquired in the second time period that is after the first time period. According to the above-described configuration, since the object is detected based on the plurality of sets of point clouds acquired from various angles, erroneous detection of the object can be effectively prevented.

The first to fifth example embodiments have been described above. The above-described example embodiments can be modified as follows, for example.

For example, the object estimation unit 12 may estimate the shape of the object 18, based on the shape of the point cloud missing region 16 illustrated in FIG. 5. Further, the object estimation unit 12 may estimate the shape of the object 18, based on the first point cloud missing region 21 and the second point cloud missing region 22 illustrated in FIG. 14.

Further, the point cloud missing region extraction unit 11 may extract the point cloud missing region 16, based on a difference between two three-dimensional point clouds which are generated at different time points. In such a case, it is preferable that the object 18 is not present at the time when one of the three-dimensional point clouds is generated.

Further, in the fourth example embodiment, it is described that by comparing two point cloud missing regions 16 extracted from two three-dimensional point clouds generated before and after the ranging position of the LiDAR apparatus 17 is shifted, the situation can be separated to whether the point cloud missing regions 16 are due to the object 18 placed on the ground, or due to the characteristics of the ground. Herein, shifting of the ranging position of the LiDAR apparatus 17 is not limited to the movement of the ranging position of the LiDAR apparatus 17 in the horizontal plane. The shifting may be a movement of the ranging position of the LiDAR apparatus 17 in the vertical direction. Even in such a case, since at least the length of the point cloud missing region 16 in the longitudinal direction increases or decreases, the situation may be separated to whether the point cloud missing regions 16 are due to the object 18 placed on the ground or due to the characteristics of the ground.

Further, in the fourth example embodiment, the point cloud missing region extraction unit 11 may calculate a difference between two three-dimensional point clouds, and extract a region where the difference is equal to or larger than a threshold value as the point cloud missing region 16.

Next, a hardware configuration of the object detection apparatus 1 is described. In the object detection apparatus 1, the point cloud missing region extraction unit 11 and the object estimation unit 12 are achieved by a processing circuit. The processing circuit may be a processor and a memory that execute a program stored in the memory, or may be dedicated hardware.

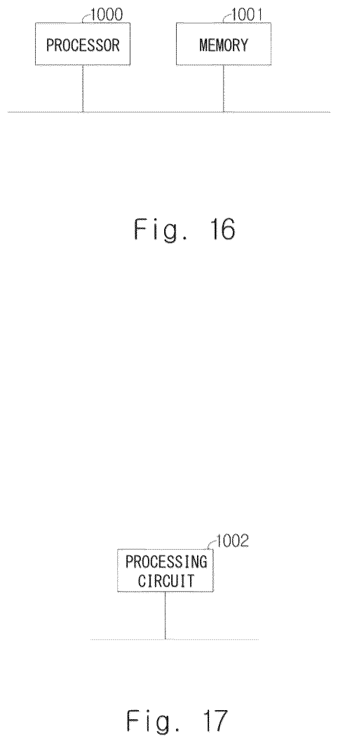

FIG. 16 is a diagram illustrating an example of a case where a processing circuit included in the object detection apparatus 1 is configured by a processor and a memory. When the processing circuit includes a processor 1000 and a memory 1001, each function of the processing circuit of the object detection apparatus 1 is achieved by software, firmware, or a combination of software and firmware. The software or firmware is written as a program and stored in the memory 1001. In the processing circuit, each function is implemented by the processor 1000 reading and executing a program stored in the memory 1001. That is, the processing circuit includes a memory 1001 for storing a program in which processing of the object detection apparatus 1 is to be executed as a result. Further, it can be said that these programs cause a computer to execute procedures and methods of the object detection apparatus 1.

Herein, the processor 1000 may be a central processing unit (CPU), a processing apparatus, an arithmetic apparatus, a microprocessor, a microcomputer, a digital signal processor (DSP), or the like. The memory 1001 includes, for example, a non-volatile or volatile semiconductor memory such as a random access memory (RAM), a read only memory (ROM), a flash memory, an erasable programmable ROM (EPROM), or an electrically EPROM (EEPROM) (registered trademark), a magnetic disk, a flexible disk, an optical disk, a compact disk, a mini disk, or a digital versatile disc (DVD).

FIG. 17 is a diagram illustrating an example of a case where a processing circuit included in the object detection apparatus 1 is configured by dedicated hardware. When the processing circuit is configured by dedicated hardware, a processing circuit 1002 illustrated in FIG. 17 may be, for example, a single circuit, a composite circuit, a programmed processor, a parallel programmed processor, an application specific integrated circuit (ASIC), a field programmable gate array (FPGA), or a combination thereof. Each function of the object detection apparatus 1 may be achieved by the processing circuit 1002 separately for each function, or each function may be implemented by the processing circuit 1002 collectively.

Note that a part of each function of the object detection apparatus 1 may be achieves by dedicated hardware, and a part thereof may be implemented by software or firmware. In such a manner, the processing circuit may implement the above-described functions by dedicated hardware, software, firmware, or a combination thereof.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Each example embodiment can be combined with other example embodiments as appropriate.

The drawings are merely examples of one or more example embodiments. Each drawing may be associated with one or more other example embodiments, rather than being associated with only one specific example embodiment. As those skilled in the art will appreciate, various features or steps described with reference to any one of the drawings may be combined with features or steps illustrated in one or more other diagrams, for example, to create example embodiments not explicitly illustrated or described. All of the features or steps illustrated in any one of the drawings to describe the example embodiments are not necessarily essential, and some features or steps may be omitted. The order of the steps described in any of the figures may be changed as appropriate.

According to the present disclosure, at the time of object detection based on a three-dimensional point cloud, the object can be detected even when a three-dimensional point cloud associated with the object cannot be acquired.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first to fifth example embodiments can be combined as desirable by one of ordinary skill in the art.

While the disclosure has been particularly illustrated and described with reference to example embodiments thereof, the disclosure is not limited to these example embodiments. It is understood by those of ordinary skill in the art that various changes in form and details may be made therein without departing from the spirit and scope of the present disclosure as defined by the claims.

A part or all of the above-described example embodiments may be described as the following supplementary notes, but are not limited thereto.

### (Supplementary Note 1)

An object detection system including:
a point cloud missing region extraction means for extracting a point cloud missing region being a region where a point cloud is missing in a three-dimensional point cloud; and
an object estimation means for estimating presence of an object, based on the point cloud missing region.

### (Supplementary Note 2)

The object detection system according to supplementary note 1, wherein the point cloud missing region is a region within a surface detected based on the three-dimensional point cloud.

### (Supplementary Note 3)

The object detection system according to supplementary note 2, wherein the point cloud missing region extraction means:
divides, in a grid shape, the surface into a plurality of cells;
calculates a point density index value or a reflection luminance index value of each cell; and
extracts, as the point cloud missing region, a set of cells in which the point density index value or the reflection luminance index value satisfies a predetermined condition.

### (Supplementary Note 4)

The object detection system according to supplementary note 2, wherein the point cloud missing region extraction means:
divides, in a grid shape, the surface into a plurality of cells;
calculates a point density index value or a reflected luminance index value of each cell; and
detects an outline of the point cloud missing region, based on a difference in the point density index value or the reflected luminance index value between two adjacent cells.

### (Supplementary Note 5)

The object detection system according to supplementary note 1, wherein the object estimation means estimates that the object is present at an end portion in a longitudinal direction of the point cloud missing region.

### (Supplementary Note 6)

The object detection system according to supplementary note 1, wherein:
the point cloud missing region extraction means extracts a first point cloud missing region and a second point cloud missing region in each of a first three-dimensional point cloud and a second three-dimensional point cloud in which ranging positions of a ranging apparatus for generating the three-dimensional point cloud are different from each other; and,
when the first point cloud missing region and the second point cloud missing region overlap with each other and an outline of the first point cloud missing region and an outline of the second point cloud missing region do not match each other, the object estimation means estimates that the object is present in an overlap region of the first point cloud missing region and the second point cloud missing region.

### (Supplementary Note 7)

The object detection system according to supplementary note 6, wherein, in a case where the ranging apparatus is mounted on a moving body and ranging using the ranging apparatus is performed while the moving body moves:
the first three-dimensional point cloud is a point cloud acquired by ranging in a first time period; and
the second three-dimensional point cloud is a point cloud acquired in a second time period which is after the first time period.

### (Supplementary Note 8)

An object detection apparatus including:
a point cloud missing region extraction means for extracting a point cloud missing region being a region where a point cloud is missing in a three-dimensional point cloud; and
an object estimation means for estimating presence of an object, based on the point cloud missing region.

### (Supplementary Note 9)

An object detection method including:
extracting a point cloud missing region being a region where a point cloud is missing in a three-dimensional point cloud; and
estimating presence of an object, based on the point cloud missing region.

### (Supplementary Note 10)

A program that causes a computer to function as:
a point cloud missing region extraction means for extracting a point cloud missing region being a region where a point cloud is missing in a three-dimensional point cloud; and
an object estimation means for estimating presence of an object, based on the point cloud missing region.

A part or all of the elements (e.g., configurations and functions) described in supplementary notes 2 to 7 depending on supplementary note 1 may be dependent on supplementary notes 8, 9, and 10 according to the same dependencies as supplementary notes 2 to 7. A part or all of the elements described in any supplementary note may be applied to various hardware, software, recording means for recording software, systems, and methods for recording software.

What is claimed is:

1. An object detection system comprising:
at least one memory storing computer-executable instructions; and
at least one processor configured to access the at least one memory and execute the computer-executable instructions to:
extract a point cloud missing region being a region where a point cloud is missing in a three-dimensional point cloud; and
estimate presence of an object, based on the point cloud missing region.

2. The object detection system according to claim 1, wherein the point cloud missing region is a region within a surface detected based on the three-dimensional point cloud.

3. The object detection system according to claim 2, wherein the at least one processor is further configured to execute the instructions to:
divide, in a grid shape, the surface into a plurality of cells;
calculate a point density index value or a reflection luminance index value of each cell; and
extract, as the point cloud missing region, a set of cells in which the point density index value or the reflection luminance index value satisfies a predetermined condition.

4. The object detection system according to claim 2, wherein the at least one processor is further configured to execute the instructions to:
divide, in a grid shape, the surface into a plurality of cells;
calculate a point density index value or a reflected luminance index value of each cell; and
detect an outline of the point cloud missing region, based on a difference in the point density index value or the reflected luminance index value between two adjacent cells.

5. The object detection system according to claim 1, wherein the at least one processor is further configured to execute the instructions to:
estimate that the object is present at an end portion in a longitudinal direction of the point cloud missing region.

6. The object detection system according to claim 1, wherein the at least one processor is further configured to execute the instructions to:
extract a first point cloud missing region and a second point cloud missing region in each of a first three-dimensional point cloud and a second three-dimensional point cloud in which ranging positions of a ranging apparatus for generating the three-dimensional point cloud are different from each other; and,
estimate, when the first point cloud missing region and the second point cloud missing region overlap with each other and an outline of the first point cloud missing region and an outline of the second point cloud missing region do not match each other, that the object is present in an overlap region of the first point cloud missing region and the second point cloud missing region.

7. The object detection system according to claim 6, wherein, in a case where the ranging apparatus is mounted on a moving body and ranging using the ranging apparatus is performed while the moving body moves:
the first three-dimensional point cloud is a point cloud acquired by ranging in a first time period; and
the second three-dimensional point cloud is a point cloud acquired in a second time period which is after the first time period.

8. An object detection apparatus comprising:
at least one memory storing computer-executable instructions; and
at least one processor configured to access the at least one memory and execute the computer-executable instructions to:
extract a point cloud missing region being a region where a point cloud is missing in a three-dimensional point cloud; and
estimate presence of an object, based on the point cloud missing region.

9. A computer-implemented object detection method comprising:
extracting a point cloud missing region being a region where a point cloud is missing in a three-dimensional point cloud; and
estimating presence of an object, based on the point cloud missing region.

10. A non-transitory computer-readable storage medium storing a program for causing a computer to execute the computer-implemented object detection method according to claim 9.
